(19) United States
(12) Patent Application Publication
(10) Pub. No.: US 2026/0255344 A1
(43) Pub. Date: Aug. 27, 2026

(54) CONFIGURABLE SIGNAL DETECTION

(71) Applicant: Telefonaktiebolaget LM Ericsson (publ), Stockholm (SE)

(72) Inventors: Fredrik HUSS, Sundbyberg (SE); Jonas KARLSSON, Upplands Väsby (SE); Lars HENNERT, Spånga (SE); Xiaoyu WEI, Solna (SE)

(21) Appl. No.: 19/160,184

(22) PCT Filed: Feb. 27, 2023
(86) PCT No.: PCT/SE2023/050173

§ 371 Date: Aug. 27, 2025

(51) Int. Cl. H04W 72/1268; H04W 28/06

(52) U.S. Cl. CPC H04W 72/1268; H04W 28/06

(57) ABSTRACT

A method implemented in a first network node configured to communicate with a second network node for detection of signaling from a wireless device is disclosed. The method includes receiving, at the first network node, a first scheduling indication from the second network node scheduling a first uplink transmission from a wireless device to the first network node during a scheduled time window. The method further includes measuring, at the first network node, signaling associated with the first uplink transmission during the scheduled time window, determining signal detection information based on the measured signaling, and communicating from the first network node a signal detection indication to the second network node, where the signal detection indication indicates signal detection information associated with the first uplink transmission.

### TECHNICAL FIELD

The present disclosure relates to wireless communications, and in particular, to configurations for supporting uplink signal detection, for example, in the fronthaul interface between a digital unit (DU) and a radio unit (RU).

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. The 3GPP is also developing standards for Sixth Generation (6G) wireless communication networks.

Embodiments of the present disclosure may relate to the fronthaul interface between a digital unit (DU) and a radio unit (RU) in a mobile network. There are several protocols for the fronthaul interface, e.g., between a DU and an RU, including, for example, Ericsson Lower Layer Split (E-LLS) or other similar proprietary protocols, and O-RAN, which is standardized in the O-RAN Alliance.

In some existing systems, the O-RAN interface is based on a functional split where the uplink channel estimation and equalization is performed in the DU. This may require that in-phase and quadrature (IQ) data be transmitted from the DU to the RU from all antennas or many beam directions. In the latter case, where beams are transmitted, analogue and/or digital beamforming may be performed in the RU.

One potential drawback of the current O-RAN interface is that transferring of the IQ data requires high bandwidth, especially in the case of large carrier bandwidth and/or many antenna ports. As a proposed improvement, there is an existing work item to improve uplink performance for Massive MIMO, such as by changing the functional split and moving parts of the receiver processing from the DU to the RU.

For example, when moving channel estimation and equalization to the RU, the information that needs to be transferred from the RU to the DU may include one or more of:
Equalized data symbols;
Effective channel or SINR for the equalized symbols (or equivalent);
Signal quality indicating if the WD signal is present (DTX indicator);
Received signal power;
Interference and noise on scheduled resource blocks; and/or
Timing error.

A signal quality discontinuous transmission (DTX) indicator may be utilized in some existing systems for the scheduler to respond with appropriate actions. If the data symbols cannot be decoded, for example, a retransmission may need to be scheduled from the wireless device (WD) (e.g., UE). Depending on the DTX indicator, either a regular retransmission may be scheduled if the WD signal was present, or a resending the initial transmission, e.g., if the WD signal was not present. This may be needed for the Hybrid automatic repeat request (HARQ) protocol to operate properly. The DTX indication may also be needed for handling measurements for signal power and timing error, e.g., to discard the measurements if the WD signal was not detected.

A failure to detect a WD signal (e.g., at a network node such as a DU or RU) may occur in several circumstances, for example:

With dynamic traffic, control information may be sent in the downlink from the network node (e.g., radio base station (RBS), DU, and/or RU) to the WD for each transmission. In case the WD cannot receive the control information correctly, it will not respond with a transmission in uplink. The control information is sent with high reliability so decoding errors are infrequent (typically 1%), and a suitable false alarm rate for the DTX indicator may be on the order of 1%.

With traffic based on configured grants, the WD has preconfigured control information for uplink transmissions. However, it will only transmit if there is data in the buffer waiting to be sent. Since traffic is typically bursty, it is common that the WD will not transmit. To avoid scheduling unnecessary retransmissions, a very low false alarm rate may be required from the DTX indicator when a WD signal is not present, typically 0.1% or even lower.

In some existing systems, e.g., the current O-RAN interface, channel estimation and equalization may be performed in the DU. From these functions, a quality measurement, e.g., signal to interference and noise ratio (SINR) may be obtained, which may then be translated to a DTX indicator that indicates if the WD signal is present or not. The translation from SINR to a DTX indicator is not a simple function though, and may depend on internal or implementation details, e.g., as to how the channel estimation and equalization is performed.

Existing systems, however, may lack configurations for supporting signal detection in the fronthaul interface.

### SUMMARY

The below example embodiments and solution(s) may achieve one or more technical effects, which may achieve one or more objects of the present disclosure. As one example of technical effect, example embodiments of the present disclosure may facilitate flexible signal detection configurations, for example, distributed between DUs and RUs, in a wireless communication system. These technical effects may achieve one or more objects of the present disclosure, for example, improved throughput, latency, and/or compatibility between DUs and RUs in a multi-vendor deployment, as compared to existing systems.

When moving the channel estimation and equalization procedures to an RU network node, in some cases, the DTX indicator measurement must also be performed in the RU. Since the interface between the DU and RU may be between different vendors, for example, there may be a need to standardize the meaning of the DTX indicator. This may be in terms of, e.g., a false detection rate when there is no WD signal transmitted.

However, since dynamic and configured grant based traffic have different requirements and characteristics, it may not be possible to specify a fixed meaning of the DTX indicator. It may also not be possible to perform the DTX indicator measurement in the DU, since it depends on the internal function of channel estimation and equalization in the RU.

Embodiments of the present disclosure may provide a flexible signal detection function for, e.g., the DTX indicator. The DTX indicator may be used for both dynamic and configured grant based traffic, for example, which may be configured with different false alarm requirements, and may be realized in several ways, for example:

When the DU is requesting the RU to receive a WD transmission, it may include information about the requirements for the signal detection function, e.g., the false alarm rate directly, or an index to a table that is fixed or can be configured in advance, and where each table gives a false alarm rate.

The RU may be configured in advance to perform multiple signal detection measurements in parallel. This configuration may be via a table that is fixed and/or can be configured with false alarm rates, and the RU may perform signal detection for each of the false alarm rates in the table.

The RU may report a probability value for whether the WD signal is present or not. This probability measurement may be independent of the internal function of channel estimation and equalization in the RU. The DU may then apply a threshold depending on the desired false alarm rate, and may judge that a signal is present if the RU reports a higher probability that a WD signal was transmitted.

In some embodiments, as an additional step, the RU may be configured to omit sending the equalized data symbols (and/or antenna combined symbols, depending on how the split between RU and DU is configured, e.g., after or before the equalizer processing occurs) in case no signal is detected from the WD. This may be based on preconfigured information and/or dynamic information in the control information communicated from the DU to the RU, e.g., included for each scheduled transmission. This step may be advantageous, e.g., for configured grant based traffic, since in many such cases, the WD may be configured to not transmit if there is no data to send. For dynamic traffic, on the other hand, in some cases it may be advantageous to always send the equalized data symbols from the RU to the DU, e.g., to improve performance for coverage limited WDs.

Embodiments of the present disclosure may provide configurations for supporting control signaling from the DU to the RU, e.g., where the RU receives an uplink transmission that is scheduled from a WD, and where the reception includes detection of the signal quality. The RU may be configured to compute/analyze/judge/etc. the result from the detection, e.g., based on one or more quality thresholds that are controlled by the DU, and the RU is configured to report the result from the detection back to the DU.

Embodiments of the present disclosure may advantageously provide configurations for supporting a functional split, e.g., in O-RAN fronthaul architecture, where channel estimation and equalization processes in the RU may be configured with a flexible DTX indicator, e.g., that may be adapted for dynamic and/or configured grant based (uplink) traffic. In some embodiments, there may be no dependency of the DTX indicator on the internal functions or implementations in the RU, e.g., so the DTX indicator may function in a multi-vendor deployment. Furthermore, in some embodiments, if the RU may be configured to omit sending the data symbols under certain configured conditions, the bandwidth requirements and consumption of the fronthaul interface may be advantageously reduced.

According to a first aspect of the present disclosure, a first network node (e.g., a DU network node) is provided for supporting configurations for signal detection. The first network node is configured to communicate, from the first network node, a first scheduling indication (e.g., signaling from a DU network node to a second network node) instructing the second network node to receive a WD transmission to the second network node, where the first scheduling indication schedules a first uplink transmission from the WD to the second network node during a scheduled time window. The first network node is configured to receive a signal detection indication from the second network node, where the signal detection indication indicates signal detection information associated with the first uplink transmission. The first network node is configured to determine, based on the signal detection information, at least one of whether the first uplink transmission was transmitted during the scheduled time window, and whether the first uplink transmission was decodable.

According to one or more embodiments of this aspect, the first network node is a digital unit (DU) network node (alternatively, the DU may be and/or may include and/or may be part of a distributed unit network node), and the second network node is a radio unit (RU) network node. According to one or more embodiments of this aspect, the signal detection indication is a discontinuous transmission (DTX) indicator. According to one or more embodiments of this aspect, the signal detection information includes at least one probability value associated with at least one of the following conditions whether the first uplink transmission was transmitted during the scheduled time window, and/or whether the first uplink transmission was decodable. According to one or more embodiments of this aspect, the second network node may be unable to and/or may lack a configuration for determining whether the first uplink transmission was decodable, and may be configured to communicate information to the first network node for use in making this determination at the first network node.

According to one or more embodiments of this aspect, the first network node is configured to determine a second scheduling indication (e.g., a downlink control indication (DCI) or similar signaling) for transmission to the WD based on the signal detection information, and is further configured to cause transmission of the second scheduling indication to the second network node for scheduling a second uplink transmission from the WD to the second network node. According to one or more embodiments of this aspect, the first scheduling indication is associated with a dynamic uplink transmission for the first uplink transmission, and the second scheduling indication for the WD schedules one of a resending of an initial transmission portion of the first uplink transmission based on determining the first uplink transmission to be not transmitted during the scheduled time window, and a sending of a retransmission of the first uplink transmission based on determining the first uplink transmission to be transmitted during the scheduled time window, and/or not decodable.

According to one or more embodiments of this aspect, the first scheduling indication schedules a configured grant uplink transmission for the first uplink transmission, and the second scheduling indication schedules a sending of a retransmission based on determining the first uplink transmission to be transmitted during the scheduled time window, and not decodable. According to one or more embodiments of this aspect, the first network node is further configured to update measurement information associated with the WD by at least one of determining and receiving additional measurements associated with the first uplink transmission, and discarding the additional measurements (e.g., determining not to update to the measurement information with the additional/new measurement information) based on at least one of determining that the first uplink transmission was not transmitted during the scheduled time window, and determining that the first uplink transmission was not decodable during the scheduled time window.

According to one or more embodiments of this aspect, the first scheduling indication indicates at least one of at least one requirement for a signal detection function, at least one false detection rate, and at least one quality threshold. According to one or more embodiments of this aspect, the first scheduling indication indicates a table of false detection rates for configuring the second network node to perform signal detection for each false detection rate in the table. According to one or more embodiments of this aspect, the first network node is further to configure the second network node with a plurality of quality thresholds, and the signal detection information includes a plurality of probability values corresponding to the plurality of quality thresholds. For example, when the network node (RU) is configured with one or more quality thresholds, each threshold may correspond to a respective false alarm rate. The RU may be configured to determine if its internal quality measure, e.g., SINR, corresponds to a false alarm rate above or below a threshold value, and may be configured to indicate this to the network node (DU), e.g., with a single bit for that quality threshold. A probability value may, for example, be represented as a continuous measure, and/or may be represented as a discrete value, e.g., a result based on a comparison with a threshold value.

According to one or more embodiments of this aspect, the first network node may be configured to configure the second network node to discard data symbols associated with the first uplink transmission based on determining that the first uplink transmission was not transmitted during the scheduled time window. According to one or more embodiments of this aspect, the first network node may be configured to configure the second network node with a table of quality thresholds, where the first scheduling indication indicates an index value corresponding to a quality threshold in the table, and the signal detection information includes a probability value associated with the indexed quality threshold.

According to another aspect of the present disclosure, a method implemented in a first network node (e.g., a DU network node) is provided for supporting configurations for signal detection. The method includes communicating, from the first network node, a first scheduling indication (e.g., signaling from a DU network node to a second network node) instructing the second network node to receive a WD transmission to the second network node, where the first scheduling indication schedules a first uplink transmission from the WD to the second network node during a scheduled time window. The method includes receiving, at the first network node, a signal detection indication from the second network node, where the signal detection indication indicates signal detection information associated with the first uplink transmission. The method includes determining, at the first network node, based on the signal detection information, at least one of whether the first uplink transmission was transmitted during the scheduled time window, and whether the first uplink transmission was decodable.

According to one or more embodiments of this aspect, the first network node is a digital unit (DU) network node (alternatively, the DU may be and/or may include and/or may be part of a distributed unit network node), and the second network node is a radio unit (RU) network node. According to one or more embodiments of this aspect, the signal detection indication is a discontinuous transmission (DTX) indicator.

According to one or more embodiments of this aspect, the signal detection information includes at least one probability value associated with at least one of the following conditions whether the first uplink transmission was transmitted during the scheduled time window, and/or whether the first uplink transmission was decodable. According to one or more embodiments of this aspect, the second network node may be unable to and/or may lack a configuration for determining whether the first uplink transmission was decodable, and the method may include communicating information to the first network node for use in making this determination at the first network node.

According to one or more embodiments of this aspect, the method includes determining at the first network node, a second scheduling indication (e.g., a downlink control indication (DCI) or similar signaling) for transmission to the WD based on the signal detection information, and communicating the second scheduling indication to the second network node for scheduling a second uplink transmission from the WD to the second network node. According to one or more embodiments of this aspect, the first scheduling indication is associated with a dynamic uplink transmission for the first uplink transmission, and the second scheduling indication for the WD schedules one of a resending of an initial transmission portion of the first uplink transmission based on determining the first uplink transmission to be not transmitted during the scheduled time window, and a sending of a retransmission of the first uplink transmission based on determining the first uplink transmission to be transmitted during the scheduled time window, and/or not decodable.

According to one or more embodiments of this aspect, the first scheduling indication schedules a configured grant uplink transmission for the first uplink transmission, and the second scheduling indication schedules a sending of a retransmission based on determining the first uplink transmission to be transmitted during the scheduled time window, and not decodable. According to one or more embodiments of this aspect, the method includes, at the first network node, updating measurement information associated with the WD by at least one of determining and receiving additional measurements associated with the first uplink transmission, and discarding the additional measurements (e.g., determining not to update to the measurement information with the additional/new measurement information) based on at least one of determining that the first uplink transmission was not transmitted during the scheduled time window, and determining that the first uplink transmission was not decodable during the scheduled time window.

According to one or more embodiments of this aspect, the first scheduling indication indicates at least one of at least one requirement for a signal detection function, at least one false detection rate, and at least one quality threshold. According to one or more embodiments of this aspect, the first scheduling indication indicates a table of false detection rates for configuring the second network node to perform signal detection for each false detection rate in the table. According to one or more embodiments of this aspect, the method includes, at the first network node, configuring the second network node with a plurality of quality thresholds, and the signal detection information includes a plurality of probability values corresponding to the plurality of quality thresholds. For example, when the network node (RU) is configured with one or more quality thresholds, each threshold may correspond to a respective false alarm rate. The RU may be configured to determine if its internal quality measure, e.g., SINR, corresponds to a false alarm rate above or below a threshold value, and may be configured to indicate this to the network node (DU), e.g., with a single bit for that quality threshold. A probability value may, for example, be represented as a continuous measure, and/or may be represented as a discrete value, e.g., a result based on a comparison with a threshold value.

According to one or more embodiments of this aspect, the method includes, at the first network node, configuring the second network node to discard data symbols associated with the first uplink transmission based on determining that the first uplink transmission was not transmitted during the scheduled time window. According to one or more embodiments of this aspect, the method includes, at the first network node, configuring the second network node with a table of quality thresholds, where the first scheduling indication indicates an index value corresponding to a quality threshold in the table, and the signal detection information includes a probability value associated with the indexed quality threshold.

According to another aspect of the present disclosure, a first network node (e.g., an RU network node) for supporting configurations for signal detection is provided. The first network node is configured to receive a first scheduling indication from the second network node scheduling a first uplink transmission from the wireless device to the first network node during a scheduled time window. The first network node is configured to measure signaling associated with the first uplink transmission during the scheduled time window. The first network node is configured to determine signal detection information based on the measured signaling. The first network node is configured to communicate (e.g., cause transmission of) a signal detection indication to the second network node, the signal detection indication indicating signal detection information associated with the first uplink transmission.

In some embodiments, the signal detection information indicates at least one of whether the first uplink transmission was transmitted during the scheduled time window, and whether the first uplink transmission was decodable. In some embodiments, the first network node is a radio unit (RU) network node, and the second network node is a digital unit (DU) network node.

In some embodiments, the signal detection indication is a discontinuous transmission, DTX, indicator. In some embodiments, the first network node is configured to determine at least one probability value associated with at least one of whether the first uplink transmission was transmitted during the scheduled time window, and whether the first uplink transmission was decodable. The signal detection information may include the at least one probability value.

In some embodiments, the first network node is configured to, responsive to transmitting the signal detection indication (to the second network node), receive a second scheduling indication for the WD (from the second network node) scheduling a second uplink transmission from the WD to the first network node.

In some embodiments, the first scheduling indication schedules a dynamic uplink transmission for the first uplink transmission, and the second scheduling indication for the WD schedules, for the second uplink transmission, one of a resending of an initial transmission portion of the first uplink transmission based on a determination that the first uplink transmission was not transmitted during the scheduled time window, and a sending of a retransmission of the first uplink transmission based on a determination that the first uplink transmission was transmitted during the scheduled time window, and not decodable. In some embodiments, the first scheduling indication schedules a configured grant uplink transmission for the first uplink transmission, and the second scheduling indication for the WD schedules, for the second uplink transmission, a sending of a retransmission based on a determination that the first uplink transmission was transmitted during the scheduled time window, and not decodable. In some embodiments, the first network node may be unable to and/or may lack a configuration for determining whether the first uplink transmission was decodable, and may be configured to communicate information to the second network node for use in making this determination at the first network node.

In some embodiments, the first scheduling indication indicates at least one of at least one requirement for a signal detection function, at least one false detection rate, and at least one quality threshold. In some embodiments, the first scheduling indication indicates a table of false detection rates, and the first network node is further configured to perform signal detection for each false detection rate in the table.

In some embodiments, the first network node is configured (e.g., based on stored configuration information, based on signaling received from the second network node, etc.), with a plurality of quality thresholds, and the signal detection information may include a plurality of probability values corresponding to the plurality of quality thresholds. In some embodiments, the first network node is configured to discard data symbols associated with the first uplink transmission based on determining that the first uplink transmission was not transmitted during the scheduled time window.

In some embodiments, the second network node is configured with a table of quality thresholds, the first scheduling indication indicates an index value corresponding to a quality threshold in the table, and the signal detection information includes a probability value associated with the indexed quality threshold.

According to another aspect of the present disclosure, a method implemented in a first network node (e.g., an RU network node) for supporting configurations for signal detection is provided. The method includes, at the first network node, receiving a first scheduling indication from the second network node scheduling a first uplink transmission from the wireless device to the first network node during a scheduled time window. The method further includes, at the first network node, measuring signaling associated with the first uplink transmission during the scheduled time window. The method further includes, at the first network node, determining signal detection information based on the measured signaling. The method further includes, at the first network node, communicating (e.g., cause transmission of) a signal detection indication to the second network node, the signal detection indication indicating signal detection information associated with the first uplink transmission.

In some embodiments, the signal detection information indicates at least one of whether the first uplink transmission was transmitted during the scheduled time window, and whether the first uplink transmission was decodable. In some embodiments, the first network node is a radio unit (RU) network node, and the second network node is a digital unit (DU) network node.

In some embodiments, the signal detection indication is a discontinuous transmission, DTX, indicator. In some embodiments, the method further includes, at the first network node, determining at least one probability value associated with at least one of whether the first uplink transmission was transmitted during the scheduled time window, and whether the first uplink transmission was decodable. The signal detection information may include the at least one probability value.

In some embodiments, the method further includes, at the first network node, responsive to transmitting the signal detection indication (to the second network node), receiving a second scheduling indication for the WD (from the second network node) scheduling a second uplink transmission from the WD to the first network node.

In some embodiments, the first scheduling indication schedules a dynamic uplink transmission for the first uplink transmission, and the second scheduling indication for the WD schedules, for the second uplink transmission, one of a resending of an initial transmission portion of the first uplink transmission based on a determination that the first uplink transmission was not transmitted during the scheduled time window, and a sending of a retransmission of the first uplink transmission based on a determination that the first uplink transmission was transmitted during the scheduled time window, and not decodable. In some embodiments, the first scheduling indication schedules a configured grant uplink transmission for the first uplink transmission, and the second scheduling indication for the WD schedules, for the second uplink transmission, a sending of a retransmission based on a determination that the first uplink transmission was transmitted during the scheduled time window, and not decodable. In some embodiments, the first network node may be unable to and/or may lack a configuration for determining whether the first uplink transmission was decodable, and the method may further include communicating information to the second network node for use in making this determination at the first network node.

In some embodiments, the first scheduling indication indicates at least one of at least one requirement for a signal detection function, at least one false detection rate, and at least one quality threshold. In some embodiments, the first scheduling indication indicates a table of false detection rates, and the method further includes, at the first network node, performing signal detection for each false detection rate in the table.

In some embodiments, the first network node is configured (e.g., based on stored configuration information, based on signaling received from the second network node, etc.), with a plurality of quality thresholds, and the signal detection information may include a plurality of probability values corresponding to the plurality of quality thresholds. In some embodiments, the method further includes, at the first network node, discarding data symbols associated with the first uplink transmission based on determining that the first uplink transmission was not transmitted during the scheduled time window.

In some embodiments, the second network node is configured with a table of quality thresholds, the first scheduling indication indicates an index value corresponding to a quality threshold in the table, and the signal detection information includes a probability value associated with the indexed quality threshold.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an example network architecture illustrating a communication system connected via an intermediate network to a host computer according to the principles in the present disclosure;

FIG. 2 is a block diagram of a host computer communicating via a network node with a wireless device over an at least partially wireless connection according to some embodiments of the present disclosure;

FIG. 3 is a flowchart illustrating example methods implemented in a communication system including a host computer, a network node and a wireless device for executing a client application at a wireless device according to some embodiments of the present disclosure;

FIG. 4 is a flowchart illustrating example methods implemented in a communication system including a host computer, a network node and a wireless device for receiving user data at a wireless device according to some embodiments of the present disclosure;

FIG. 5 is a flowchart illustrating example methods implemented in a communication system including a host computer, a network node and a wireless device for receiving user data from the wireless device at a host computer according to some embodiments of the present disclosure;

FIG. 6 is a flowchart illustrating example methods implemented in a communication system including a host computer, a network node and a wireless device for receiving user data at a host computer according to some embodiments of the present disclosure;

FIG. 7 is a flowchart of an example process in a first network node (e.g., a DU) for supporting configurations for signal detection with a second network node (e.g., an RU), according to some embodiments of the present disclosure; and

FIG. 8 is a flowchart of an example process in a first network node (e.g., an RU) for supporting configurations for signal detection with a second network node (e.g., a DU), according to some embodiments of the present disclosure.

### DETAILED DESCRIPTION

Before describing in detail example embodiments, it is noted that the embodiments reside primarily in combinations of apparatus components and processing steps related to supporting configurations for signal detection, e.g., in a fronthaul interface. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), Radio Unit (RU), Digital Unit (DU), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node. A network node may also include one or more (or all) parts of a distributed radio base station such as centralized digital units (DUs) and/or radio units (RUs) or Remote Radio Units (RRUs), sometimes referred to as Remote Radio Heads (RRHs). Such remote radio units may or may not be integrated with an antenna as an antenna integrated radio.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or one or more network node(s) (e.g., DUs, RUs, etc.) may be distributed over a plurality of wireless devices and/or network nodes and/or DUs and/or RUs. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide configurations for supporting signal detection, e.g., in a fronthaul interface.

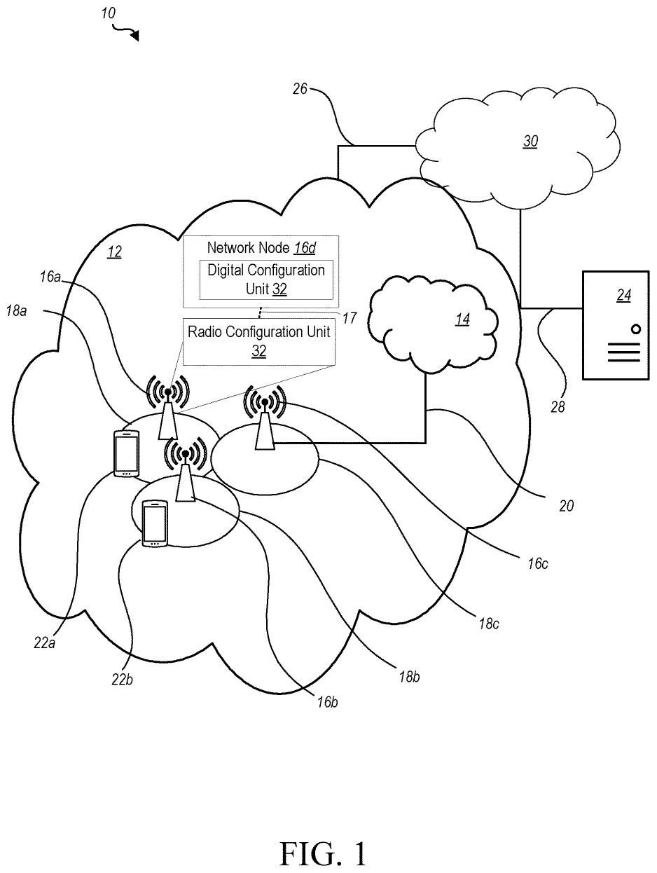

Referring now to the drawing figures, in which like elements are referred to by like reference numerals, there is shown in FIG. 1 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c, 16d (referred to collectively as network nodes 16), such as NBs, eNBs, gNBs, DUs, RUs, or other types of wireless access points or network nodes. One or more network nodes 16, e.g., network nodes 16a, 16b, 16c, may correspond to and/or define a corresponding coverage area 18a, 18b, 18c (referred to collectively as coverage areas 18). One or more network nodes 16, e.g., network node 16a, may be characterized as and/or may include an RU. One or more network nodes, e.g., network node 16d, may be characterized as and/or may include a DU. Network node 16a and network node 16d may communicate via a wired or wireless connection 17, which may be a fronthaul interface. Network node 16a (e.g., an RU) and network node 16d (e.g., a DU) may be implemented in physically and/or logically separate devices, hardware, premises, etc., and/or may be co-located in the same device, hardware, premises, etc.

One or more network nodes 16a, 16b, 16c, 16d may be connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and four network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 1 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A first network node 16a (e.g., an RU network node 16a) is configured to include a Radio Configuration Unit 32 which is configured for supporting signal detection, e.g., in a fronthaul interface with another network node 16d (e.g., a DU network node 16d). A second network node 16a (e.g., a DU network node 16d) is configured to include a Digital Configuration unit 34 which is configured for supporting signal detection, e.g., in a fronthaul interface with another network node 16a (e.g., an RU).

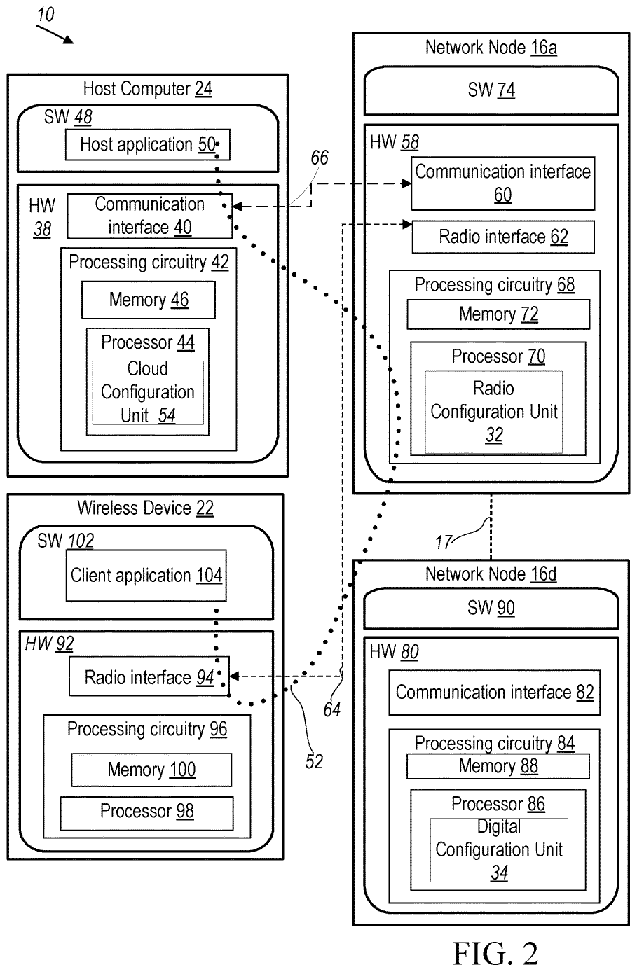

Example implementations, in accordance with an embodiment, of the WD 22, network node 16a, network node 16d, and host computer 24 discussed in the preceding paragraphs will now be described with reference to FIG. 2. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network nodes 16 and or the wireless device 22. The processing circuitry 42 of the host computer 24 may include a Cloud Configuration unit 54 configured to enable the service provider to observe/monitor/control/transmit to/receive from/etc. the network nodes 16 and or the wireless device 22, e.g., for supporting configurations for signal detection.

The communication system 10 further includes a network node 16a (e.g., an RU network node 16a) provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, e.g., network node 16d (e.g., a DU) as well as a radio interface 62 for setting up and maintaining at least a wireless connection 64 with a WD 22 located in a coverage area 18 served by the network node 16a. The radio interface 62 may be formed as or may include, for example, one or more RF transmitters, one or more RF receivers, and/or one or more RF transceivers. The communication interface 60 may be configured to facilitate a connection 66 to the host computer 24 and/or connection 17 to network node 16d (e.g., a DU). The connection 66 and/or connection 17 may be direct or it may pass through a core network 14 of the communication system 10 and/or through one or more intermediate networks 30 outside the communication system 10.

In the embodiment shown, the hardware 58 of the network node 16a further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16a further has software 74 stored internally in, for example, memory 72, or stored in external memory (e.g., database, storage array, network storage device, etc.) accessible by the network node 16a via an external connection. The software 74 may be executable by the processing circuitry 68. The processing circuitry 68 may be configured to control any of the methods and/or processes described herein and/or to cause such methods, and/or processes to be performed, e.g., by network node 16a. Processor 70 corresponds to one or more processors 70 for performing network node 16a functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16a. For example, processing circuitry 68 of the network node 16a may include Radio Configuration unit 32 configured to support signal detection, e.g., of uplink signaling from a WD 22, in the fronthaul interface (e.g., connection 17) with the network node 16d.

The communication system 10 further includes a network node 16d (e.g., a DU network node 16d) provided in a communication system 10 and including hardware 80 enabling it to communicate with the host computer 24, other network nodes 16, e.g., network node 16a, and with the WD 22. The hardware 80 may include a communication interface 82 for setting up and maintaining a wired or wireless connection with an interface of a different communication device of the communication system 10, e.g., network node 16a (e.g., an RU). In some embodiments, the network node 16d may lack a radio interface for setting up and maintaining at least a wireless connection with a WD 22, which functionality may be provided by a network node 16a in communication with network node 16d via connection 17, for example. In some embodiments, the network node 16d and network node 16a may be implemented in the same physical and/or logical device, hardware, etc., and/or may be implemented with separate devices, hardware, etc. The communication interface 82 may be configured to facilitate a connection 66 to the host computer 24 and/or connection 17 to network node 16a (e.g., an RU). The connection 66 and/or connection 17 may be direct or it may pass through a core network 14 of the communication system 10 and/or through one or more intermediate networks 30 outside the communication system 10. The network node 16d (e.g., a DU) may be in communication with and/or may be configured to control, schedule, configure, etc., additional network nodes 16b, 16c, etc. In other words, a DU network node 16d may be configured to communicate with, control, schedule, configure, etc., multiple RU network nodes 16, or a single RU network node 16a.

In the embodiment shown, the hardware 80 of the network node 16d further includes processing circuitry 84. The processing circuitry 84 may include a processor 86 and a memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) the memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16d further has software 90 stored internally in, for example, memory 88, or stored in external memory (e.g., database, storage array, network storage device, etc.) accessible by the network node 16d via an external connection. The software 90 may be executable by the processing circuitry 84. The processing circuitry 84 may be configured to control any of the methods and/or processes described herein and/or to cause such methods, and/or processes to be performed, e.g., by network node 16d. Processor 86 corresponds to one or more processors 86 for performing network node 16d functions described herein. The memory 88 is configured to store data, programmatic software code and/or other information described herein. In some embodiments, the software 90 may include instructions that, when executed by the processor 86 and/or processing circuitry 84, causes the processor 86 and/or processing circuitry 84 to perform the processes described herein with respect to network node 16d. For example, processing circuitry 84 of the network node 16d may include Digital Configuration unit 34 configured to support signal detection, e.g., of uplink signaling from a WD 22, in the fronthaul interface (e.g., connection 17) with the network node 16a.

The communication system 10 further includes the WD 22 already referred to. The WD 22 may have hardware 92 that may include a radio interface 94 configured to set up and maintain a wireless connection 64 with a network node 16 (e.g., network node 16a) serving a coverage area 18 in which the WD 22 is currently located. The radio interface 94 may be formed as or may include, for example, one or more RF transmitters, one or more RF receivers, and/or one or more RF transceivers.

The hardware 92 of the WD 22 further includes processing circuitry 96. The processing circuitry 96 may include a processor 98 and memory 100. In particular, in addition to or instead of a processor, such as a central processing unit, and memory, the processing circuitry 96 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 98 may be configured to access (e.g., write to and/or read from) memory 100, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 102, which is stored in, for example, memory 100 at the WD 22, or stored in external memory (e.g., database, storage array, network storage device, etc.) accessible by the WD 22. The software 102 may be executable by the processing circuitry 96. The software 102 may include a client application 104. The client application 104 may be operable to provide a service to a human or non-human user via the WD 22, with the support of the host computer 24. In the host computer 24, an executing host application 50 may communicate with the executing client application 104 via the OTT connection 52 terminating at the WD 22 and the host computer 24. In providing the service to the user, the client application 104 may receive request data from the host application 50 and provide user data in response to the request data. The OTT connection 52 may transfer both the request data and the user data. The client application 104 may interact with the user to generate the user data that it provides.

The processing circuitry 96 may be configured to control any of the methods and/or processes described herein and/or to cause such methods, and/or processes to be performed, e.g., by WD 22. The processor 98 corresponds to one or more processors 98 for performing WD 22 functions described herein. The WD 22 includes memory 100 that is configured to store data, programmatic software code and/or other information described herein. In some embodiments, the software 102 and/or the client application 104 may include instructions that, when executed by the processor 98 and/or processing circuitry 96, causes the processor 98 and/or processing circuitry 96 to perform the processes described herein with respect to WD 22.

In some embodiments, the inner workings of the network node 16a, network node 16d, WD 22, and host computer 24 may be as shown in FIG. 2 and independently, the surrounding network topology may be that of FIG. 1.

In FIG. 2, the OTT connection 52 has been drawn abstractly to illustrate the communication between the host computer 24 and the wireless device 22 via the network node(s) 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 102 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 94 and/or processing circuitry 96 configured to perform the functions and/or methods described herein for preparing/initiating/maintaining/supporting/ending a transmission to the network node(s) 16, and/or preparing/terminating/maintaining/supporting/ending in receipt of a transmission from the network node 16.

Although FIGS. 1 and 2 show various “units” such as Radio Configuration unit 32, and Digital Configuration unit 34 as being within a respective processor/device, it is contemplated that these units may be implemented such that a portion of the unit is stored in a corresponding memory within the processing circuitry. In other words, the units may be implemented in hardware or in a combination of hardware and software within the processing circuitry.

FIG. 3 is a flowchart illustrating an example method implemented in a communication system, such as, for example, the communication system of FIGS. 1 and 2, in accordance with one embodiment. The communication system may include a host computer 24, a network node 16 and a WD 22, which may be those described with reference to FIG. 2. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 104, associated with the host application 50 executed by the host computer 24 (Block S108).

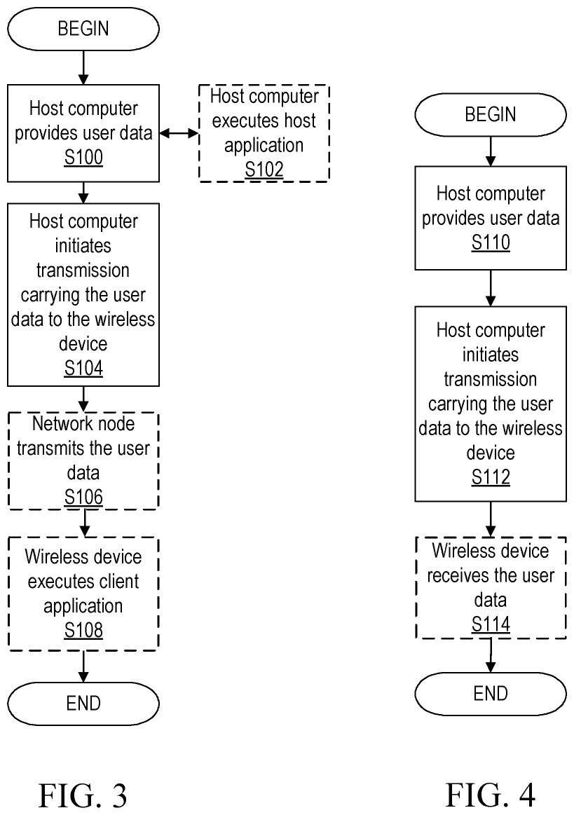

FIG. 4 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

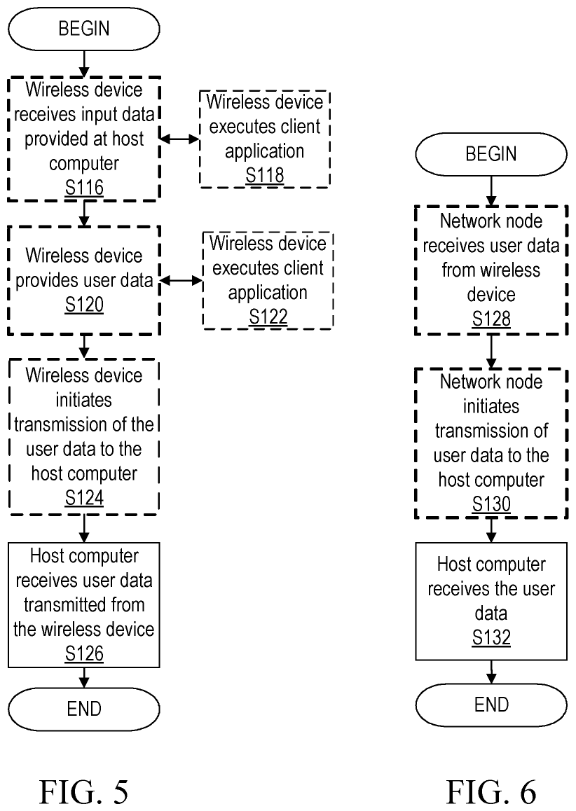

FIG. 5 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, the WD 22 receives input data provided by the host computer 24 (Block S116). In an optional substep of the first step, the WD 22 executes the client application 104, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 104 (Block S122). In providing the user data, the executed client application 104 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 6 is a flowchart illustrating an example method implemented in a communication system, such as, for example, the communication system of FIG. 1, in accordance with one embodiment. The communication system may include a host computer 24, network node(s) 16, and a WD 22, which may be those described with reference to FIGS. 1 and 2. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

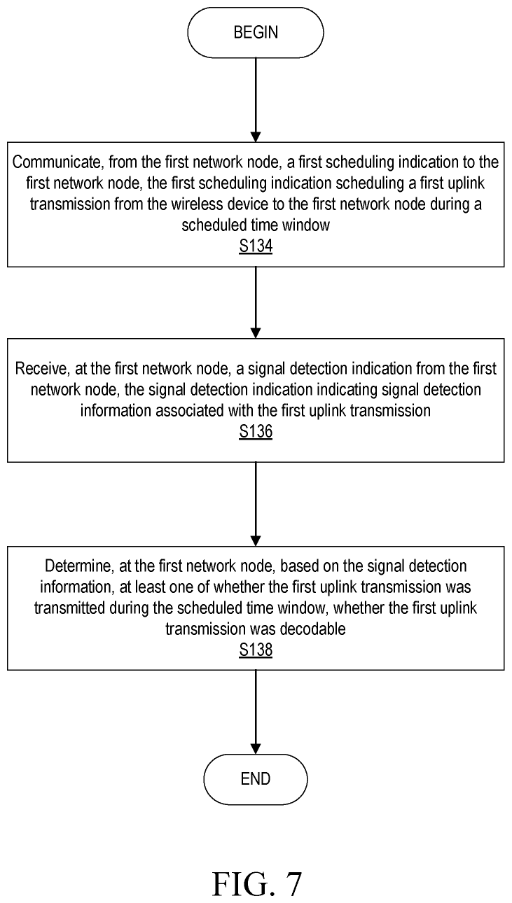

FIG. 7 is a flowchart of an example process in a first network node 16d (e.g., a DU network node 16d) for supporting configurations for signal detection. One or more blocks described herein may be performed by one or more elements of network node 16d such as by one or more of processing circuitry 84 (including the Digital Configuration unit 34), processor 86, and/or communication interface 82. Network node 16d is configured to communicate (Block S134), from the first network node 16d, a first scheduling indication (e.g., signaling from a DU network node 16d to an RU network node 16a) instructing the RU network node 16a to receive a WD 22 transmission) to the second network node 16a, the first scheduling indication scheduling a first uplink transmission from the WD 22 to the second network node 16a during a scheduled time window. Network node 16d is configured to receive (Block S136) a signal detection indication from the second network node 16a, the signal detection indication indicating signal detection information associated with the first uplink transmission. Network node 16d is configured to determine (Block S138), based on the signal detection information, at least one of whether the first uplink transmission was transmitted during the scheduled time window, and whether the first uplink transmission was decodable.

In some embodiments, the first network node 16d is a digital unit (DU) network node 16d (alternatively, the DU may be and/or may include and/or may be part of a distributed unit network node 16), and the second network node 16a is a radio unit (RU) network node. In some embodiments, the signal detection indication is a discontinuous transmission (DTX) indicator. In some embodiments, the signal detection information includes at least one probability value associated with at least one of the following conditions whether the first uplink transmission was transmitted during the scheduled time window, and/or whether the first uplink transmission was decodable. In some embodiments, the second network node 16a may be unable to and/or may lack a configuration for determining whether the first uplink transmission was decodable, and may be configured to communicate information to the first network node 16d for use in making this determination at the first network node 16d.

In some embodiments, the first network node 16d is configured to determine a second scheduling indication (e.g., a downlink control indication (DCI) or similar signaling) for transmission to the WD 22 based on the signal detection information, and is further configured to cause transmission of the second scheduling indication to the second network node 16a for scheduling a second uplink transmission from the WD 22 to the second network node 16a. In some embodiments, the first scheduling indication is associated with a dynamic uplink transmission for the first uplink transmission, and the second scheduling indication for the WD 22 schedules one of a resending of an initial transmission portion of the first uplink transmission based on determining the first uplink transmission to be not transmitted during the scheduled time window, and a sending of a retransmission of the first uplink transmission based on determining the first uplink transmission to be transmitted during the scheduled time window, and/or not decodable.

In some embodiments, the first scheduling indication schedules a configured grant uplink transmission for the first uplink transmission, and the second scheduling indication schedules a sending of a retransmission based on determining the first uplink transmission to be transmitted during the scheduled time window, and not decodable. In some embodiments, the first network node 16d is further configured to update measurement information associated with the WD 22 by at least one of determining and receiving additional measurements associated with the first uplink transmission, and discarding the additional measurements (e.g., determining not to update to the measurement information with the additional/new measurement information) based on at least one of determining that the first uplink transmission was not transmitted during the scheduled time window, and determining that the first uplink transmission was not decodable during the scheduled time window.

In some embodiments, the first scheduling indication indicates at least one of at least one requirement for a signal detection function, at least one false detection rate, and at least one quality threshold. In some embodiments, the first scheduling indication indicates a table of false detection rates for configuring the second network node 16a to perform signal detection for each false detection rate in the table. In some embodiments, the first network node 16d is further to configure the second network node 16a with a plurality of quality thresholds, and the signal detection information includes a plurality of probability values corresponding to the plurality of quality thresholds. For example, when the network node 16a (RU) is configured with one or more quality thresholds, each threshold may correspond to a respective false alarm rate. The RU may be configured to determine if its internal quality measure, e.g., SINR, corresponds to a false alarm rate above or below a threshold value, and may be configured to indicate this to the first network node 16d (DU), e.g., with a single bit for that quality threshold. A probability value may, for example, be represented as a continuous measure, and/or may be represented as a discrete value, e.g., a result based on a comparison with a threshold value.

In some embodiments, the first network node 16d may be configured to configure the second network node 16a to discard data symbols associated with the first uplink transmission based on determining that the first uplink transmission was not transmitted during the scheduled time window. In some embodiments, the first network node 16d may be configured to configure the second network node 16a with a table of quality thresholds, where the first scheduling indication indicates an index value corresponding to a quality threshold in the table, and the signal detection information includes a probability value associated with the indexed quality threshold.

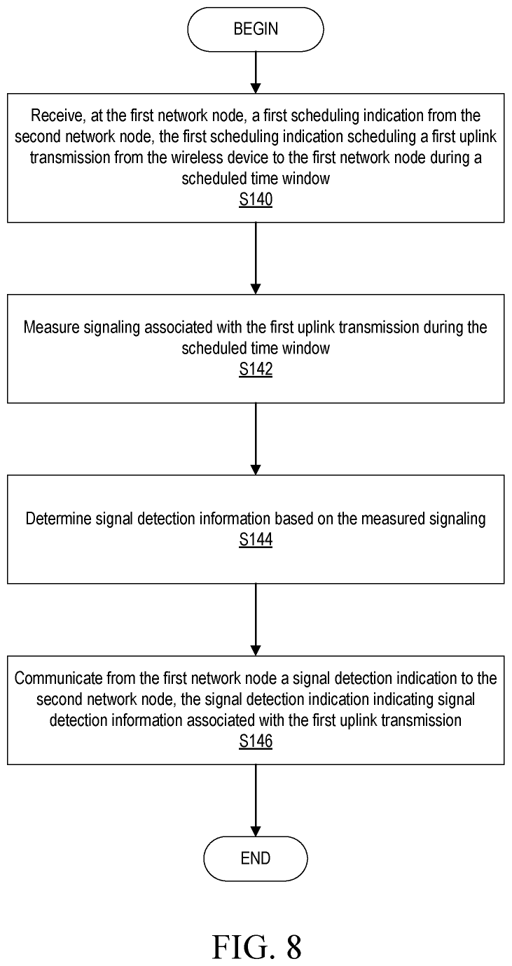

FIG. 8 is a flowchart of an example process in a first network node 16a (e.g., an RU network node 16a) for supporting configurations for signal detection. One or more blocks described herein may be performed by one or more elements of network node 16a such as by one or more of processing circuitry 68 (including the Radio Configuration unit 32), processor 70, radio interface 62 and/or communication interface 60. Network node 16a is configured to receive (Block S140) a first scheduling indication from the second network node 16d, the first scheduling indication scheduling a first uplink transmission from the wireless device 22 to the first network node 16a during a scheduled time window. Network node 16a is configured to measure (Block S142) signaling associated with the first uplink transmission during the scheduled time window. Network node 16a is configured to determine (Block S144) signal detection information based on the measured signaling. Network node 16a is configured to communicate (e.g., cause transmission of) (Block S146) a signal detection indication to the second network node 16d, the signal detection indication indicating signal detection information associated with the first uplink transmission.

In some embodiments, the signal detection information indicates at least one of whether the first uplink transmission was transmitted during the scheduled time window, and whether the first uplink transmission was decodable. In some embodiments, the first network node 16a is a radio unit (RU) network node 16a, and the second network node 16d is a digital unit (DU) network node 16d.

In some embodiments, the signal detection indication is a discontinuous transmission, DTX, indicator. In some embodiments, the first network node 16a is configured to determine at least one probability value associated with at least one of whether the first uplink transmission was transmitted during the scheduled time window, and whether the first uplink transmission was decodable. The signal detection information may include the at least one probability value.

In some embodiments, the first network node 16a is configured to, responsive to transmitting the signal detection indication (to the second network node 16d), receive a second scheduling indication for the WD 22 (from the second network node 16d) scheduling a second uplink transmission from the WD 22 to the first network node 16a.

In some embodiments, the first scheduling indication schedules a dynamic uplink transmission for the first uplink transmission, and the second scheduling indication for the WD 22 schedules, for the second uplink transmission, one of a resending of an initial transmission portion of the first uplink transmission based on a determination that the first uplink transmission was not transmitted during the scheduled time window, and a sending of a retransmission of the first uplink transmission based on a determination that the first uplink transmission was transmitted during the scheduled time window, and not decodable. In some embodiments, the first scheduling indication schedules a configured grant uplink transmission for the first uplink transmission, and the second scheduling indication for the WD 22 schedules, for the second uplink transmission, a sending of a retransmission based on a determination that the first uplink transmission was transmitted during the scheduled time window, and not decodable. In some embodiments, the first network node 16a may be unable to and/or may lack a configuration for determining whether the first uplink transmission was decodable, and may be configured to communicate information to the second network node 16d for use in making this determination at the first network node 16a.

In some embodiments, the first scheduling indication indicates at least one of at least one requirement for a signal detection function, at least one false detection rate, and at least one quality threshold. In some embodiments, the first scheduling indication indicates a table of false detection rates, and the first network node 16a is further configured to perform signal detection for each false detection rate in the table.

In some embodiments, the first network node 16a is configured (e.g., based on stored configuration information, based on signaling received from the second network node 16d, etc.), with a plurality of quality thresholds, and the signal detection information may include a plurality of probability values corresponding to the plurality of quality thresholds. In some embodiments, the first network node 16a is configured to discard data symbols associated with the first uplink transmission based on determining that the first uplink transmission was not transmitted during the scheduled time window.

In some embodiments, the first network node 16a (and/or second network node 16d) is configured with a table of quality thresholds, the first scheduling indication indicates an index value corresponding to a quality threshold in the table, and the signal detection information includes a probability value associated with the indexed quality threshold.

Having described the general process flow of arrangements of the disclosure and having provided examples of hardware and software arrangements for implementing the processes and functions of the disclosure, the sections below provide details and examples of arrangements for signal detection, e.g., of uplink signaling from a WD 22, e.g., in the fronthaul interface between an RU network node 16a and a DU network node 16d.

Some embodiments of the present disclosure may include, for example, one or more of the following steps performed at a network node 16a and/or network node 16d and/or WD 22.
1. As an optional step, the network node 16d (e.g., DU) configures the network node 16a (e.g., RU) via a management plane (e.g., via connection 17) with configuration information such as a table of one or more quality thresholds in terms of false detection rates or equivalents. In some embodiments, a fixed table may be used, e.g., based on a definition in a standard or specifications, which may be stored, e.g., in memory 88 and/or memory 100.
2. For a scheduled WD 22 transmission, the DU network node 16d sends scheduling information to the RU network node 16a via a control plane (e.g., via connection 17) including, e.g., which table index value(s) for quality threshold(s) to use for signal detection.
3. After receiving and processing the signal in the RU network node 16a, the results from signal detection are sent from the RU network node 16a to the DU network node 16d.
4. As an optional step, the RU network node 16a may be configured to use the result from the signal detection to determine whether the equalized data symbols should be sent to the DU network node 16d.
5. The DU network node 16d may be configured to use the result from signal quality detection in future scheduling decisions and/or updating of measurement information, e.g., for received power and timing error. For example, the DU network node 16d may be configured to determine scheduling configurations, under the following conditions:
   a. Dynamic traffic: The DU network node 16d may be configured to schedule the WD 22 to resend an initial transmission and/or send retransmission, e.g., in case data could not be decoded.
   b. Configured grant: The DU network node 16d may be configured to schedule the WD 22 to only retransmit if the DU network node 16d and/or RU network node 16a detected a transmission but cannot decode the data.
   c. The DU network node 16d may be configured to only update measurement information with new/additional measurements if there was a signal detected for the new/additional measurements.

In some embodiments, for a “retransmission”, the network node 16a (e.g., RU network node 16a and/or radio base station) may be configured to assume that the WD 22 has (successfully) received the first transmission from the network node 16a. The WD 22 may then be configured/scheduled (e.g., by network node 16d and/or network node 16a) to retransmit a different set of coded bits (e.g., using “incremental redundancy”), such as by using a different value of a redundancy version parameter. In some embodiments, the network node 16a and/or network node 16d and/or WD 22 may be configured to change frequency allocation(s), e.g., by using certain modulation and coding scheme (MCS) values that only indicate modulation (and not code rate), since the transport block size may be known to the WD 22.

In some embodiments, for a “resending of an initial transmission”, the network node 16a (e.g., RU network node 16a and/or radio base station) may be configured to assume that the WD 22 missed (e.g., did not properly receive) control information (e.g., from the network node 16d and/or network node 16a) associated with (e.g., scheduling) the first transmission (e.g., from the WD 22). The network node 16d and/or network node 16a may then be configured to include (e.g., with scheduling information) “full” (i.e., more verbose, detailed, etc.) control information (e.g., because the previous MCS value(s) may not be usable), and the network nodes 16 and/or WD 22 may be configured to use redundancy version zero, e.g., so that systematic bits are transmitted and data is decodable.

Some embodiments of the present disclosure may include, for example, one or more of the following steps performed at a network node 16a and/or network node 16d and/or WD 22.
1. As an optional step, the first network node 16d (e.g., DU) configures the second network node 16a (e.g., RU), e.g., via a management plane (e.g., connection 17) with a table of multiple quality thresholds in terms of false detection rate or equivalents. Alternatively, a fixed table may be used from the specifications.
2. For each scheduled WD 22 transmission (e.g., uplink transmission), the DU network node 16d sends scheduling information to the RU network node 16a, e.g., via control plane (e.g., via connection 17).
3. After receiving and processing the signal in the RU network node 16a, the results from signal detection for each of the quality thresholds are sent from the RU network node 16a to the DU network node 16d.
4. As an optional step, the RU network node 16a may be configured to use the result from the signal detection to decide if the equalized data symbols should be sent to the DU network node 16d. The RU network node 16a may be configured with which threshold(s) to use.
5. The DU network node 16d may be configured to use the result from signal quality detection for selecting the measurement(s) with the desired threshold(s), e.g., in future scheduling decisions and/or updating of measurement information, e.g., for received power and timing error.

Some embodiments of the present disclosure may include, for example, one or more of the following steps performed at a network node 16a and/or network node 16d and/or WD 22.
1. For each scheduled WD 22 transmission, the network node 16d (e.g., DU network node 16d) is configured to send scheduling information to the network node 16a (e.g., RU network node 16a), e.g., via control plane (e.g., via connection 17).
2. After receiving and processing the signal (e.g., from the WD 22) in the RU network node 16a, the received signal quality is mapped by RU network node 16a to a probability value, e.g., for indicating/determining whether the WD 22 signal is present or not. The probability value may be represented in terms of false detection rate or equivalent, and the result after mapping may be sent from the RU network node 16a to the DU network node 16d.
3. The DU network node 16d may be configured to perform signal detection based on the mapped probability value received from the RU network node 16a and a quality threshold in terms of false detection rate or equivalent.
4. The DU network node 16d is configured to utilize the result from signal quality detection in future scheduling decisions and/or updating of measurements for received power and timing error for the WD 22.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:
DTX Discontinuous Transmission
DU Digital Unit
HARQ Hybrid Automatic Repeat Request
O-RAN Open Radio Access Network
RBS Radio Base Station
RU Radio Unit
SINR Signal to Interference and Noise Ratio
UE User Equipment

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1-52. (canceled)

53. A digital unit, DU, network node configured to communicate with a radio unit, RU, network node for detection of signaling from a wireless device, the RU network node being in communication with the wireless device, the DU network node comprising processing circuitry configured to:
configure the RU network node with a plurality of quality thresholds;
communicate, from the DU network node, a first scheduling indication to the RU network node, the first scheduling indication scheduling a first uplink transmission from the wireless device to the RU network node during a scheduled time window;
receive a signal detection indication from the RU network node, the signal detection indication indicating signal detection information associated with the first uplink transmission, and the signal detection information including a plurality of probability values corresponding to the plurality of quality thresholds; and
determine, based on the signal detection information, at least one of:
whether the first uplink transmission was transmitted during the scheduled time window; and
whether the first uplink transmission was decodable.

54. The DU network node of claim 53, wherein the signal detection indication is a discontinuous transmission, DTX, indicator.

55. The DU network node of claim 53, wherein the signal detection information includes at least one probability value associated with at least one of the following conditions:
whether the first uplink transmission was transmitted during the scheduled time window; and
whether the first uplink transmission was decodable.

56. The DU network node of claim 53, wherein the processing circuitry is further configured to:
determine a second scheduling indication for transmission to the wireless device based on the signal detection information; and
communicating the second scheduling indication to the RU network node for scheduling a second uplink transmission from the wireless device to the RU network node.

57. The DU network node of claim 56, wherein the first scheduling indication is associated with a dynamic uplink transmission for the first uplink transmission; and
the second scheduling indication for the wireless device schedules one of:
a resending of an initial transmission portion of the first uplink transmission based on determining the first uplink transmission to be not transmitted during the scheduled time window; and
a sending of a retransmission of the first uplink transmission based on determining the first uplink transmission to be:
transmitted during the scheduled time window; and
not decodable.

58. The DU network node of claim 56, wherein the first scheduling indication schedules a configured grant uplink transmission for the first uplink transmission; and
the second scheduling indication schedules a sending of a retransmission based on determining the first uplink transmission to be:
transmitted during the scheduled time window; and
not decodable.

59. The DU network node of claim 53, wherein the first scheduling indication indicates at least one of:
at least one requirement for a signal detection function;
at least one false detection rate; and
at least one quality threshold.

60. The DU network node of claim 53, wherein the first scheduling indication indicates a table of false detection rates for configuring the RU network node to perform signal detection for each false detection rate in the table.

61. The DU network node of claim 53, wherein the processing circuitry is further configured to:
configure the RU network node to discard data symbols associated with the first uplink transmission based on determining that the first uplink transmission was not transmitted during the scheduled time window.

62. The DU network node of claim 53, wherein the processing circuitry is further configured to:
configure the RU network node with a table of quality thresholds;
the first scheduling indication indicating an index value corresponding to a quality threshold in the table; and
the signal detection information including a probability value associated with the indexed quality threshold.

63. A method implemented in a digital unit, DU, network node configured to communicate with a receiving unit, RU, network node for detection of signaling from a wireless device, the RU network node being in communication with the wireless device, the method comprising:
configuring the RU network node with a plurality of quality thresholds; and
communicating, from the DU network node, a first scheduling indication to the RU network node, the first scheduling indication scheduling a first uplink transmission from the wireless device to the RU network node during a scheduled time window;
receiving, at the DU network node, a signal detection indication from the RU network node, the signal detection indication indicating signal detection information associated with the first uplink transmission and the signal detection indication including a plurality of probability values corresponding to the plurality of quality thresholds; and
determining, at the DU network node, based on the signal detection information at least one of:
whether the first uplink transmission was transmitted during the scheduled time window; and
whether the first uplink transmission was decodable.

64. A radio unit, RU, network node configured to communicate with a digital unit, DU, network node for detection of signaling from a wireless device, the RU network node being in communication with a wireless device, the RU network node comprising processing circuitry configured to:
receive a first scheduling indication from the DU network node, the first scheduling indication scheduling a first uplink transmission from the wireless device to the RU network node during a scheduled time window, wherein the RU network node is configured by the DU network node with a plurality of quality thresholds;
measure signaling associated with the first uplink transmission during the scheduled time window;
determine signal detection information based on the measured signaling; and
communicate a signal detection indication to the DU network node, the signal detection indication indicating signal detection information associated with the first uplink transmission and the signal detection information including a plurality of probability values corresponding to the plurality of quality thresholds, wherein the signal detection information indicates at least one of:
whether the first uplink transmission was transmitted during the scheduled time window; and
whether the first uplink transmission was decodable.

65. The RU network node of claim 64, wherein the signal detection indication is a discontinuous transmission, DTX, indicator.

66. The RU network node of claim 64, wherein the processing circuitry is further configured to:
determine at least one probability value associated with at least one of:
whether the first uplink transmission was transmitted during the scheduled time window; and
whether the first uplink transmission was decodable; and
the signal detection information including the at least one probability value.

67. The RU network node of claim 64, wherein the processing circuitry is further configured to:
responsive to transmitting the signal detection indication, receive a second scheduling indication for the wireless device scheduling a second uplink transmission from the wireless device to the RU network node.

68. The RU network node of claim 67, wherein the first scheduling indication schedules a dynamic uplink transmission for the first uplink transmission; and
the second scheduling indication for the wireless device schedules, for the second uplink transmission, one of:
a resending of an initial transmission portion of the first uplink transmission based on a determination that the first uplink transmission was not transmitted during the scheduled time window; and
a sending of a retransmission of the first uplink transmission based on a determination that the first uplink transmission was:
transmitted during the scheduled time window; and
not decodable.

69. The RU network node of claim 67, wherein the first scheduling indication schedules a configured grant uplink transmission for the first uplink transmission; and
the second scheduling indication for the wireless device schedules, for the second uplink transmission, a sending of a retransmission based on a determination that the first uplink transmission was:
transmitted during the scheduled time window; and
not decodable.

70. The RU network node of claim 64, wherein the first scheduling indication indicates at least one of:
at least one requirement for a signal detection function;
at least one false detection rate; and
at least one quality threshold.

71. The RU network node of claim 64, wherein the first scheduling indication indicates a table of false detection rates; and
the processing circuitry is further configured to perform signal detection for each false detection rate in the table.

72. The RU network node of claim 64, wherein the processing circuitry is further configured to:
discard data symbols associated with the first uplink transmission based on determining that the first uplink transmission was not transmitted during the scheduled time window.

73. The RU network node of claim 64, wherein the DU network node is configured with a table of quality thresholds;
the first scheduling indication indicating an index value corresponding to a quality threshold in the table; and
the signal detection information including a probability value associated with the indexed quality threshold.

74. A method implemented in a radio unit, RU, network node configured to communicate with a digital unit, DU, network node for detection of signaling from a wireless device, the RU network node being in communication with a wireless device, the method comprising:
receiving, at the RU network node, a first scheduling indication from the DU network node, the first scheduling indication scheduling a first uplink transmission from the wireless device to the RU network node during a scheduled time window, wherein the RU network node is configured by the DU network node with a plurality of quality thresholds;
measuring signaling associated with the first uplink transmission during the scheduled time window;
determining signal detection information based on the measured signaling; and
communicating from the RU network node a signal detection indication to the DU network node, the signal detection indication indicating signal detection information associated with the first uplink transmission and the signal detection information including a plurality of probability values corresponding to the plurality of quality thresholds, wherein the signal detection information indicates at least one of:
whether the first uplink transmission was transmitted during the scheduled time window, and
whether the first uplink transmission was decodable.
